(19) United States
(12) Patent Application Publication
(10) Pub. No.: US 2023/0164043 A1
(43) Pub. Date: May 25, 2023

(54) SERVICE APPLICATION DETECTION

(71) Applicant: VEEGO SOFTWARE LTD., Ramat Gan (IL)

(72) Inventors: Denis SIROV, Tel Aviv (IL); Reffael CASPI, Tel Aviv (IL); Ronen KONDRATOVSKY, Petah Tikva (IL)

(21) Appl. No.: 17/990,901

(22) Filed: Nov. 21, 2022

Related U.S. Application Data
(60) Provisional application No. 63/281,705, filed on Nov. 21, 2021.

(51) Int. Cl. H04L 43/026; H04L 43/04; H04L 41/16; H04L 43/0894; H04L 43/067

(52) U.S. Cl. CPC H04L 43/026; H04L 43/04; H04L 41/16; H04L 43/0894; H04L 43/067

(57) ABSTRACT

A method comprising: receiving, at a network interface, telemetry data associated with a plurality of data flows, wherein each of said plurality of data flows is associated with an instance of usage of one of a set of known applications or Internet services; segmenting each of the data flows into time windows; processing the telemetry data to calculate, for each of the data flows, a set of features associated with each of the time windows in each of the data flows, and at a training stage, training a machine learning model on a training dataset comprising the sets of features for each of the data flows, and labels indicating an identity of a particular one of the application or internet services associated with each of the data flows, to obtain a trained machine learning classifier.

### CROSS-REFERENCE TO RELATED APPLICATIONS

This application claims the benefit of priority from U.S. Provisional Patent Application No. 63/281,705, filed Nov. 21, 2021, entitled, “SERVICE APPLICATION DETECTION,” the contents of which are hereby incorporated by reference in their entirety.

### FIELD OF THE INVENTION

The invention relates to the field of computer networks and machine learning.

### BACKGROUND

Network data traffic monitoring, and in particular, the identification of the particular services and/or applications using a network's resources, is of great importance for internet service providers (ISPs) and network operators and administrators. Accurate information about the traffic mix carried by an IP network can allow network operators to identify the requirements of different users from the underlying infrastructure efficient design, and provision resources appropriately. In addition, they can track the growth of different user populations and design the network to accommodate the diverse needs, as well as shed light on the emerging applications as well as possible misuse of network resources.

Different services and applications have different traffic patterns and associated Quality of Service (QoS) requirements, such as bandwidth, loss, delay, jitter (variation in delay), and best-effort options. For instance, some applications require high bandwidth and low jitter for the network traffic to reach its destination, while other applications may by highly sensitive to delay. Thus, accurate traffic classification has become one of the prerequisites for advanced network management tasks, such as monitoring, QoS management, dynamic pricing, and security.

Accordingly, to properly address the challenges of these varying QoS requirements and manage network resources efficiently, it is vital for service providers and Internet Service Providers (ISPs) to be able to recognize different types of applications utilizing network resources.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a system comprising at least one hardware processor; and a non-transitory computer-readable storage medium having stored thereon program instructions, the program instructions executable by the at least one hardware processor to: receive, at a network interface, telemetry data associated with a plurality of data flows, wherein each of the plurality of data flows is associated with an instance of usage of one of a set of known applications or Internet services, segment each of the data flows into time windows, process the telemetry data to calculate, for each of the data flows, a set of features associated with at least one of the following categories of features: (i) a ratio of the time windows within each of the data flows having a data rate or packet rate which spike above a predetermined threshold, (ii) a ratio between inbound and outbound data or packets within each of the time windows in each of the data flows, and (iii) a value associated with time periods within each of the time windows in each of the data flow having inbound or outbound data or packet rates below a predetermined amount, and at a training stage, train a machine learning model on a training dataset comprising: (iv) the sets of features for each of the data flows, and (v) labels indicating an identity a particular the application or Internet service associated with the data flow, to obtain a trained machine learning classifier configured to output a classification of unseen target telemetry data as originating from a particular one of the applications or Internet services.

There is also provided, in an embodiment, a computer-implemented method comprising: receiving, at a network interface, telemetry data associated with a plurality of data flows, wherein each of the plurality of data flows is associated with an instance of usage of one of a set of known applications or Internet services; segmenting each of the data flows into time windows; processing the telemetry data to calculate, for each of the data flows, a set of features associated with at least one of the following categories of features: (i) a ratio of the time windows within each of the data flows having a data rate or packet rate which spike above a predetermined threshold, (ii) a ratio between inbound and outbound data or packets within each of the time windows in each of the data flows, and (iii) a value associated with time periods within each of the time windows in each of the data flow having inbound or outbound data or packet rates below a predetermined amount; and at a training stage, training a machine learning model on a training dataset comprising: (iv) the sets of features for each of the data flows, and (v) labels indicating an identity a particular the application or Internet service associated with the data flow, to obtain a trained machine learning classifier configured to output a classification of unseen target telemetry data as originating from a particular one of the applications or Internet services.

There is further provided, in an embodiment, a computer program product comprising a non-transitory computer-readable storage medium having program instructions embodied therewith, the program instructions executable by at least one hardware processor to: receive, at a network interface, telemetry data associated with a plurality of data flows, wherein each of the plurality of data flows is associated with an instance of usage of one of a set of known applications or Internet services; segment each of the data flows into time windows; process the telemetry data to calculate, for each of the data flows, a set of features associated with at least one of the following categories of features: (i) a ratio of the time windows within each of the data flows having a data rate or packet rate which spike above a predetermined threshold, (ii) a ratio between inbound and outbound data or packets within each of the time windows in each of the data flows, and (iii) a value associated with time periods within each of the time windows in each of the data flow having inbound or outbound data or packet rates below a predetermined amount; and at a training stage, train a machine learning model on a training dataset comprising: (iv) the sets of features for each of the data flows, and (v) labels indicating an identity a particular the application or Internet service associated with the data flow, to obtain a trained machine learning classifier configured to output a classification of unseen target telemetry data as originating from a particular one of the applications or Internet services.

In some embodiments, the program instructions are further executable to apply, and the method further comprises applying, at an inference stage, the trained machine learning classifier to unseen target telemetry data, to classify the unseen target telemetry data as originating from a particular one of the applications or internet services.

In some embodiments, the predetermined threshold is a dynamic threshold expressed as a function of the data rate or packet rate over each of the time windows.

In some embodiments, the training dataset further comprises one or more statistics calculated with respect to at least some of the categories of features, and the statistics are selected from the group consisting of: mean, average, minimum value, maximum value, variance, standard deviation, and distribution.

In some embodiments, at least some of the instances of usage comprise two or more data flow connections, wherein the program instructions are further executable to calculate, and the method further comprises calculating, features associated with connection multiplexity selected from the group consisting of: a number and type of the connections associated with a particular one of the instances of usage; a number of opened and closed connections per each of the time windows associated with a particular one of the instances of usage; an order of opening of different connection types associated with a particular one of the instances of usage; and statistics calculated with respect to each of the features associated with connection multiplexity.

In some embodiments, the training dataset further comprises the features associated with connection multiplexity.

In some embodiments, the training dataset further comprises one or more statistics calculated with respect to at least some of the features associated with connection multiplexity, wherein the statistics are selected from the group consisting of: mean, average, minimum value, maximum value, variance, standard deviation, and distribution.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 illustrates an exemplary network environment which may provide for application level classification, in accordance with various aspects of the present disclosure;

FIG. 2 shows a block diagram of an exemplary system for machine learning-based automated, real-time, application-level classification of network traffic within a communications network, in accordance with various aspects of the present disclosure;

FIG. 3A illustrates the functional steps in a method for training a machine learning model to perform automated, real-time, application-level classification of network traffic within a communications network, in accordance with various aspects of the present disclosure;

FIG. 3B provides an overview of a pipeline for training a machine learning model of the present disclosure, in accordance with various aspects of the present disclosure;

FIG. 4A illustrates the functional steps in a method for automated, real-time, application-level classification of network traffic within a communications network, by inferencing a trained machine learning classifier, in accordance with various aspects of the present disclosure; and

FIG. 4B illustrates an inferencing pipeline of a machine learning classifier of the present disclosure, in accordance with various aspects of the present disclosure.

### DETAILED DESCRIPTION

Disclosed herein is a technique, embodied in a system, computer-implemented method, and computer program product, which provides for machine learning-based automated, real-time, application-level classification of network data traffic. In some embodiments, the present disclosure provides for classification of data traffic transmitted over a data communications network, as originating from a particular application or Internet service within a plurality of service categories, including, but not limited to, media streaming (including audio and video streaming), file downloading, file uploading, online gaming, conferencing, social network usage, internet browsing, VPN session, electronic mail usage, and remote desktop session. In some embodiments, application-level classification of network data traffic may enable further determining of service priority and/or Quality of Service (QoS) requirements.

As noted above, network traffic characterization and application-level classification are crucial components for advanced network management tasks by Internet Service Providers (ISPs) and service providers, to allow for efficient allocation of resources, as well as QoS and network security management.

In a non-limiting example, in the context of residential Wi-Fi networks, QoS variability experienced by client devices drives many complaints to ISPs. However, the performance of the home or residential network is largely beyond the access and control of the ISPs. Poor performance from Wi-Fi connected devices may be caused by a variety of factors, such as devices being too far from a wireless router or AP, the router or AP being turned off or not working properly, the router or AP itself receiving poor service from the external network, interference from other equipment within the home, or authentication issues between networked devices and the router or AP. Thus, in many cases, an important first step in determining a cause for poor service is identifying the type or category of service, as well as the actual application being used by an end-device, because each service type and application requires a different set of service attributes to enable a reliable and stable connection.

However, several factors combine to make network traffic characterization and application-level detection and classification a challenging task. These factors include, but are not limited to:
Regulatory and user-imposed privacy requirements, which may limit the ability of enterprises to monitor network traffic in a way that may reveal user-level personal information;
a growing trend of data encryption of network traffic, which randomizes the original data in a way which limits the ability to detect discriminative patterns to aid in classification;
the use of common libraries among applications, especially in mobile applications, as well as the use of content delivery networks, tunnelling through Virtual Private Networks (VPNs), or hosting by cloud providers, which cause applications to share many network traffic characteristics, and may mask and obfuscate the source and origin of the data; and
the dynamic nature of application network traffic, which often depends on user interaction with the application;

Known techniques for network traffic characterization and application-level identification include a combination of one or more of a port-based approach, payload inspection techniques, and statistical approaches. Traffic classification via port number uses the information in the TCP/UDP headers of the packets to extract the port number. After the extraction of the port number, it is compared with the IANA TCP/UDP port number is assumed to be associated with a particular application. However, the pervasiveness of port obfuscation, network address translation (NAT), port forwarding, protocol embedding and random ports assignments have significantly reduced the accuracy of this approach. Payload inspection techniques based on the analysis of information available in the application layer payload of packets. However, this approach suffers from the need for updating patterns whenever a new protocol is released, as well as user privacy issues. Statistical approaches are based on the assumption that the underlying traffic for each application has unique statistical patterns.

Accordingly, in some embodiments, the present disclosure provides for a machine learning-based framework for training a machine learning model that can receive telemetry data with respect to data traffic flows over a network interface, and classify the telemetry data as associated with a particular application or Internet service. For example, a trained machine learning model of the present disclosure may be inferenced on received telemetry data traffic with respect to data traffic flows over a network interface, to classify the telemetry data traffic as associated with one of a predetermined set of applications or Internet services.

In some embodiments, the present disclosure provides for training a machine learning model using a training dataset comprising one or more sets of features calculated from telemetry data with respect to data traffic flows over a network interface. In some embodiments, a training dataset of the present disclosure may be constructed from telemetry data associated with a plurality of data traffic flows captured over one or more communications networks, wherein the data traffic sessions may be associated with two or more categories and/or classes of interest, e.g., data traffic associated with two or more particular applications or Internet services, within one or more service categories. Thus, in some embodiments, such a dataset may comprise features calculated from telemetry data extracted from multiple data traffic session instances associated with two or more categories and/or classes of interest, e.g., features calculated from data traffic session instances associated with 2, 3, 4, 5, 10, 15, or more categories and/or classes of interest, each of which may represent a different application or Internet service.

Accordingly, in some embodiments, the captured telemetry data may be used to generate one or more sets of features for a training dataset of the present disclosure, comprising telemetry data representing a plurality of data traffic sessions associated with multiple categories and/or classes, each of which may represent a particular application or Internet service. In some embodiments, a training dataset of the present disclosure may also be enhanced with features calculated from data traffic session instances associated with additional and/or other unrecognized applications or Internet services, and/or other data traffic categories.

In some embodiments, the present disclosure provides for analyzing and processing the telemetry data, to extract one or more categories of telemetry data features. In some embodiments, analyzing and processing the telemetry data includes segmenting each data traffic session into a sequence of time windows, which may be partially overlapping, and extracting the specified features separately from each time window. In some embodiments, the extracted features may include, but are not limited to, data flow-level or temporal (i.e., time-related) features, as well as packet-level or size-based features. In some embodiments, each of these features may be associated with one of the following categories of features:
Data “spikiness,” i.e., the rate of data and/or packets arriving within each specified time window within a data traffic session.
A ratio of inbound-to-outbound data and/or packets within a specified time window in a data traffic session.
Inter-arrival timing of data and/or packets within a specified time window in a data traffic session.
Data traffic session connection attributes, e.g., the number and handling of open connections associated with the requested service.

In some embodiments, one or more data preprocessing operations may be applied to the raw data and/or to the calculated and extracted features. The preprocessing operations comprise at least one of data cleaning/filtering, data normalizing, data quality control, and/or any other suitable preprocessing method or technique. In some embodiments, some data preprocessing operations may occur before and/or after the feature extraction stage. In some embodiments, a data preprocessing stage may comprise a data cleaning operation configured to remove irrelevant or redundant data packets from the telemetry data, which may take place before the feature extraction stage. In some embodiments, data normalization may comprise normalization of the extracted features. In some embodiments, the preprocessing stage may also further include feature selection, dimensionality reduction, and/or any other suitable preprocessing method or technique.

In some embodiments, a training dataset of the present disclosure comprises a set of labeled examples on which a machine learning model of the present disclosure may be trained to build a set of classification rules, to classify unseen examples. Accordingly, in some embodiments, the features extracted from the plurality of data traffic may be labeled with a label indicating a “ground truth” class or category associated with the particular data traffic, e.g., a specific application or Internet service that is the source of the data traffic. In some embodiments, a training dataset of the present disclosure may be labeled using manual, semi-automated, or automated methods. For example, in some embodiments, a training dataset may comprise a portion of labeled feature sets, combined with unlabeled features.

In some embodiments, a machine learning model may be trained on the training dataset constructed as detailed above, to obtain a trained machine learning model able to classify a received unseen data traffic as originating from one of several predetermined applications or Internet services.

In some embodiments, a technique is disclosed herein for classification of a data traffic session over a data communications network, to identify an application-level source of the data traffic. In a non-limiting example, a software agent hosted at a node of a data communications network (e.g., a home network access point or a remote server) monitors a data traffic session associated with, e.g., a device within the network. The software agent analyzes the data traffic to determine a set of features associated with the data traffic session. The software agent then applies a trained machine learning model to the set of features, to classify the data traffic session as originating from one of several predetermined applications or Internet services.

In accordance with example embodiments of the present invention, a system is further disclosed for application-level classification of a data traffic session over a data communications network. The system comprises at least a receiver configured to receive a plurality of data packets of the data traffic session. The system further comprises a processor configured to calculate a plurality of features that characterize the data traffic session, and classify the data traffic session as originating from one of several predetermined applications or Internet services.

In a non-limiting example, the present disclosure may operate within the context of a local area network (LAN) comprising one or more end devices, e.g., end stations (STAs). A LAN may be connected to the Internet through an access point (AP) and/or a gateway, such as a broadband modem and/or router. In a typical LAN environment, a user may access the Internet by connecting a client device (which may be a wireless device) to a server on the Internet, via intermediate devices and networks. In some implementations, a client device may be connected to a LAN configured to communicate with servers on a wide area network (e.g., the Internet) via an access network. In some embodiments, a LAN may be a wireless local area network (WLAN), which includes, e.g., wireless STAs connected through a wireless AP, e.g., a wireless router. In some embodiments, STAs within a LAN can be, but are not limited to, a tablet, a desktop computer, a laptop computer, a handheld computer, a cellular telephone, a smartphone, a network appliance, a camera, a media player, a navigation device, a game console, or a combination of any these data processing devices or other data processing devices.

LANs and WLANs, as described herein, may include wired or wireless client devices connected through a wired or wireless access point or router. The LANs or WLANs of the present disclosure may include a computer network that covers a limited geographic area (e.g., a home, school, computer laboratory, an office building) using a wired or wireless distribution method. The LAN/WLAN may be connected with the access network via a broadband modem. The wide area network (WAN) may include servers, such as authentication servers, web servers, electronic messaging servers, etc., accessible to the client device. Home gateways and access points, as described herein, may perform many of the interfacing functions between the home network and an ISP's network. In a large number of cases, the role of the home gateway is combined with that of a wireless AP.

As used herein, the term ‘application-level classification’ may refer to techniques for identifying, determining and/or classifying data traffic provided to, accessed by, requested by, and/or consumed by an STA within a LAN, as originating from one of several predetermined applications or Internet services.

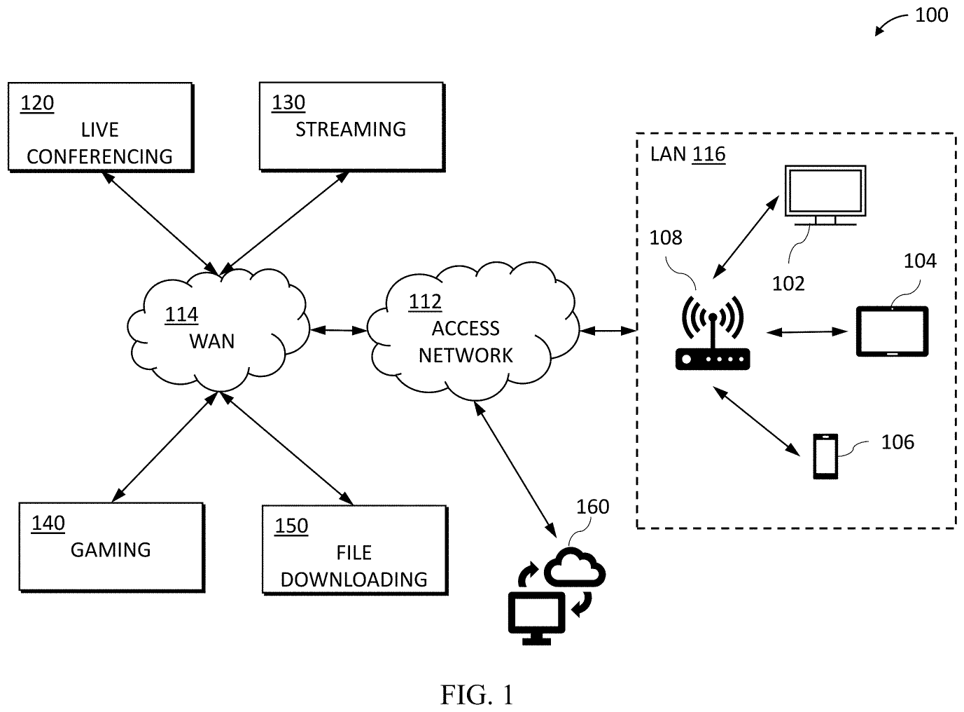

FIG. 1 illustrates an exemplary network environment 100 which the present machine learning classifier may be deployed to perform application-level classification of network data traffic. Network environment 100 includes STAs 102, 104 and 106 communicably connected to one or more service and/or content providers, such as Internet services 120-150, via LAN 116, access network 112 and wide area network 114. LAN 116 includes AP 108 and STAs 102-106. LAN 116 may be connected with the access network via a broadband modem.

Each of STAs 102-106 can represent various forms of computing devices, e.g., a desktop computer, a laptop computer, a handheld computer, a tablet, a cellular telephone, a smartphone, a network appliance, a camera, a media player, a navigation device, a gaming console, or a combination of any these devices. Each of Internet services 120-150 may be a system or device having a processor, a memory, and communications capability for providing services over an internet connection, such as, but not limited to, media streaming (including audio and video streaming), file downloading, file uploading, online gaming, live conferencing, social networking, Internet browsing, VPN sessions, electronic mail, and/or remote desktop sessions.

In some example aspects, each of Internet services 120-150 can be a single computing device, for example, a computer server. In other embodiments, each of Internet services 120-150 can represent more than one computing device working together to perform the actions of a server computer (e.g., cloud computing). Further, each of Internet services 120-150 can represent various forms of servers including, but not limited to an application server, a proxy server, a network server, an authentication server, an electronic messaging server, a content server, a server farm, etc., accessible to STAs 102-106.

A user of an STA 102-106 may interact with the content and/or services provided by Internet services 120-150 through a client application installed at STAs 102-106. Alternatively, the user may interact with the content and/or services provided by Internet services 120-150 through a web browser application install on STAs 102-106. Communication between STAs 102-106 and Internet services 120-150 may be facilitated through LAN 116, access network 112 and/or wide area network 114.

In some aspects, STAs 102-106 may communicate through a communication interface (not shown), which may include digital signal processing circuitry where necessary. The communication interface may provide for communications under various modes or protocols, for example, Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, for example, using a Bluetooth, Wi-Fi, or other such transceiver.

Wide area network 114 can include, but is not limited to, a large computer network that covers a broad area (e.g., across metropolitan, regional, national or international boundaries), for example, the Internet, a private network, an enterprise network, a cellular network, or a combination thereof connecting any number of mobile clients, fixed clients, and servers. Further, wide area network 114 can include, but is not limited to, any of the following network topologies, including a bus network, a star network, a ring network, a mesh network, a star-bus network, tree or hierarchical network, and the like. Wide area network 114 may include one or more wired or wireless network devices that facilitate device communications between STAs 102-106 and Internet services 120-150, such as switch devices, router devices, relay devices, etc., and/or may include one or more servers.

Access network 112 can include, but is not limited to, a cable access network, public switched telephone network, and/or fiber optics network to connect wide area network 114 to LAN 116. Access network 112 may provide last mile access to internet. Access network 112 may include one or more routers, switches, splitters, combiners, termination systems, central offices for providing broadband services. In some embodiments, access network 112 may include remote server 160 which may perform data traffic monitoring, analysis, and similar operation with respect to LAN 116.

LAN 116 can include, but is not limited to, a computer network that covers a limited geographic area (e.g., a home, school, computer laboratory, a business enterprise, or an office building) using a wired or wireless distribution method. Client devices (e.g., STAs 102-106) may associate with an AP (e.g., AP 108) to access LAN 116 using Wi-Fi standards.

For exemplary purposes, LAN 116 is illustrated as including multiple STAs 102-106; however, LAN 116 may include only one of STAs 102-106. In some implementations, LAN 116 may be, or may include, one or more of a bus network, a star network, a ring network, a relay network, a mesh network, a star-bus network, a tree or hierarchical network, and the like.

AP 108 can include a network-connectable device, such as a hub, a router, a switch, a bridge, or an AP. The network-connectable device may also be a combination of devices, such as a Wi-Fi router that can include a combination of a router, a switch, and an AP. Other network-connectable devices can also be utilized in implementations of the subject technology. AP 108 can allow client devices (e.g., STAs 102-106) to connect to wide area network 114 via access network 112.

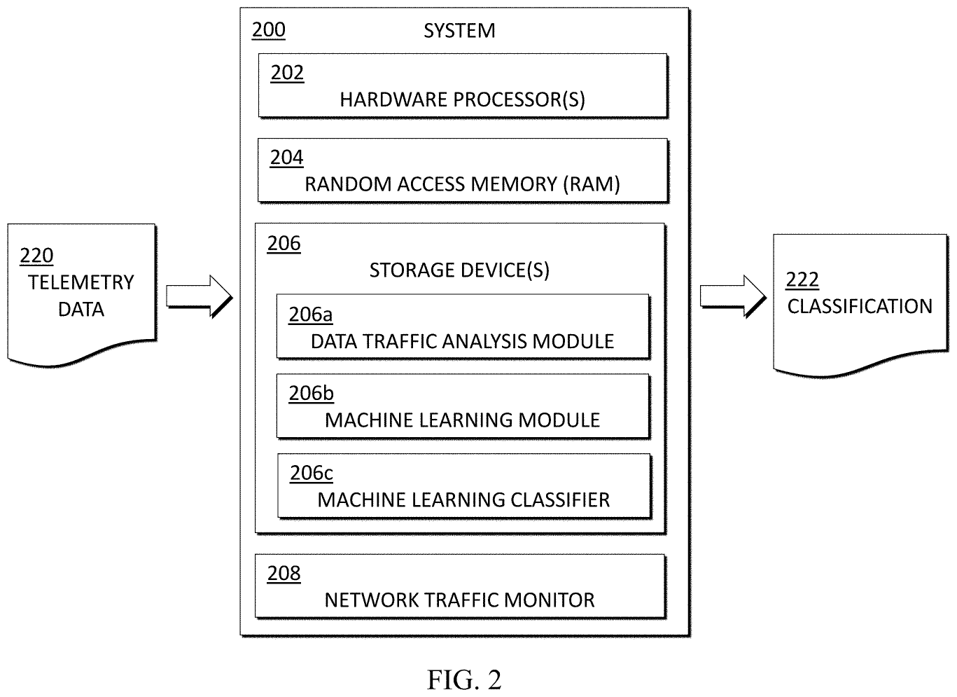

FIG. 2 shows a block diagram of an exemplary system 200 for machine learning-based automated, real-time, application-level classification of network traffic within a communications network, in accordance with various aspects of the present disclosure.

System 200 as described herein is only an exemplary embodiment of the present invention, and in practice may have more or fewer components than shown, may combine two or more of the components, or a may have a different configuration or arrangement of the components. The various components of system 200 may be implemented in hardware, software or a combination of both hardware and software. In various embodiments, system 200 may comprise a dedicated hardware device, or may be implement as a hardware and/or software module into an existing device, e.g., an AP, such as AP 108 within LAN 116 shown in FIG. 1, or may be part of remote server 160 shown in FIG. 1.

System 200 may include one or more hardware processor(s) 202, a random-access memory (RAM) 204, one or more non-transitory computer-readable storage device(s) 206, and a network traffic monitor 208. Components of system 200 may be co-located or distributed, or the system may be configured to run as one or more cloud computing ‘instances,’ ‘containers,’ ‘virtual machines,’ or other types of encapsulated software applications, as known in the art.

Storage device(s) 206 may have stored thereon program instructions and/or components configured to operate hardware processor(s) 202. The program instructions may include one or more software modules, such as data traffic analysis module 206a, machine learning module 206b, and/or machine learning classifier 206c. The software components may include an operating system having various software components and/or drivers for controlling and managing general system tasks (e.g., memory management, storage device control, power management, etc.), and facilitating communication between various hardware and software components. System 200 may operate by loading instructions of the various software modules 206a-206c into RAM 204 as they are being executed by processor(s) 202.

The data traffic monitor 208 may be configured to continuously monitor one or more data traffic sessions over one or more data communication networks, such as LAN 116 shown in FIG. 1.

Data traffic monitor 208 may monitor and capture telemetry data, captured through active and/or passive probing of endpoint devices. In some embodiments, probing by data traffic monitor 208 may entail sending one or more of the following probes:
DHCP probes with helper addresses.
SPAN probes, to get messages in INIT-REBOOT and SELECTING states, use of ARP cache for IP/MAC binding, etc.
Netflow probes.
HTTP probes to obtain information such as the OS of the device, Web browser information, etc.
RADIUS probes.
SNMP to retrieve MIB object or receives traps.
DNS probes to get the Fully Qualified Domain Name (FQDN).
Active or SNMP scanning to retrieve the MAC address of a device or other types of information.

In some embodiments, telemetry data captured by data traffic monitor 208 may also include data traffic monitor 208 may include data packets, user data, or control information associated with various information channels (e.g., control channels, data channels, and information related to managing service discovery over network connections). Information received at data traffic monitor 208 may be processed and transmitted to data traffic analysis module 206a and/or to other components of system 200.

In some embodiments, data traffic monitor 208 may be completely software based, hardware based, or a combination of both. Data traffic monitor 208 may comprise one or more monitoring points, which may be implemented in software and/or hardware devices distributed over a plurality of networks. In some cases, data traffic monitor 208 may be implemented by a vendor, such as an ISP, to monitor network data traffic over a backbone or access network, where the data traffic is associated with a plurality of LANs serviced by the ISP.

In some embodiments, telemetry data captured by data traffic monitor 208 originate in wired networks, but can also originate in wireless networks and virtual environments. In some examples, data traffic monitor 208 may include a circuit or circuitry for monitoring and identifying one or more attributes of a connection. In some embodiments, data traffic monitor 208 may be configured to monitor and determine, e.g., connection throughput (e.g., connection bitrate, packets per second, etc.). In some embodiments, data traffic monitor 208 may comprise a ‘sniffer’ or network analyzer designed to capture telemetry data on a network. In some embodiments, data traffic monitor 208 may be configured to capture telemetry data associated with one or more types or categories of service provided over an internet connection, e.g., media streaming (including audio and video streaming), file downloading, file uploading, online gaming, live conferencing, social networking, Internet browsing, VPN sessions, electronic mail, and/or remote desktop sessions.

In some embodiments, network traffic monitor 208 may employ any suitable hardware and/or software tool to capture traffic telemetry data. For example, network traffic monitor 208 may be deployed to monitor one or more access networks, access points, end devices, and/or hosts, to telemetry data associated with data flows sent to or received from the internet. In some embodiments, network traffic monitor 208 may be configured to determine a corresponding source or application associated with each captured data packet. In some embodiments, network traffic monitor 208 may be configured to timestamp each received packet, and to label each received packet with its associated source or application.

In some embodiments, data traffic analysis module 206a may be configured to receive network data traffic and to preprocess and/or process and analyze the data according to any desirable or suitable analysis technique, procedure or algorithm. In some embodiments, data traffic analysis module 206a may be configured to perform any one or more of the following: data cleaning, data filtering, data normalizing, and/or feature extraction and calculation.

In some embodiments, the instructions of machine learning module 206b may cause system 200 to receive training data, process it, and output one or more training datasets, each comprising a plurality of annotated data samples, based on one or more annotation schemes. The instructions of machine learning module 206b may further cause system 200 to train and implement one or more machine learning models, e.g., machine learning classifier 206c, using the one or more training datasets constructed by machine learning module 206b.

In some embodiments, machine learning module 206b may implement one or more machine learning models using various model architectures, e.g., convolutional neural network (CNN), recurrent neural network (RNN), or deep neural network (DNN), adversarial neural network (ANN), and/or any other suitable machine learning model architecture. The terms ‘machine learning model’ and ‘machine learning classifier’ are used interchangeably, and may be abbreviated ‘model’ or ‘classifier.’ These terms are intended to refer to any type of machine learning model which is capable of producing an output, e.g., a classification, a prediction, or generation of new data, based on a training scheme which trains a model to perform a specified prediction or classification. Classification algorithms can include linear discriminant analysis, classification and regression trees/decision tree learning/random forest modeling, nearest neighbor, support vector machine, logistic regression, generalized linear models, Naive Bayesian classification, and neural networks, among others

In some embodiments, the instructions of machine learning classifier 206c may cause system 200 to receive, at an inference stage, input target telemetry data 220 originating from an unseen application or Internet service, and to output an application-level classification 222 of the target input telemetry data 220, which predicts the particular application or Internet service associated with input target telemetry data 220.

In some embodiments, machine learning classifier 206c may be configured to execute any one or more classification algorithms with respect to received data, to generate predictions. The terms ‘classification’ and ‘prediction’ may be used herein interchangeably and are intended to refer to any type of output of a machine learning model. This output may be in the form of a class and a confidence score which indicates the certainty that input data belong to a certain class of a predetermined set of classes. Various types of machine learning models may be configured to handle different types of input and produce respective types of output; all such types are intended to be covered by present embodiments. The terms ‘class,’ ‘category,’ ‘category label,’ ‘label,’ and ‘type’ when referring to service types can be considered synonymous terms with regard to the application-level classification of network data traffic.

System 200 as described herein is only an exemplary embodiment of the present invention, and in practice may be implemented in hardware only, software only, or a combination of both hardware and software. System 200 may have more or fewer components and modules than shown, may combine two or more of the components, or may have a different configuration or arrangement of the components. System 200 may include any additional component enabling it to function as an operable computer system, such as a motherboard, data busses, power supply, a network interface card, a display, an input device (e.g., keyboard, pointing device, touch-sensitive display), etc. (not shown). Moreover, components of system 200 may be co-located or distributed, or the system may be configured to run as one or more cloud computing ‘instances,’ ‘containers,’ ‘virtual machines,’ or other types of encapsulated software applications, as known in the art. As one example, system 200 may in fact be realized by two separate but similar systems. These two systems may cooperate, such as by transmitting data from one system to the other (over a local area network, a wide area network, etc.), so as to use the output of one module as input to the other module.

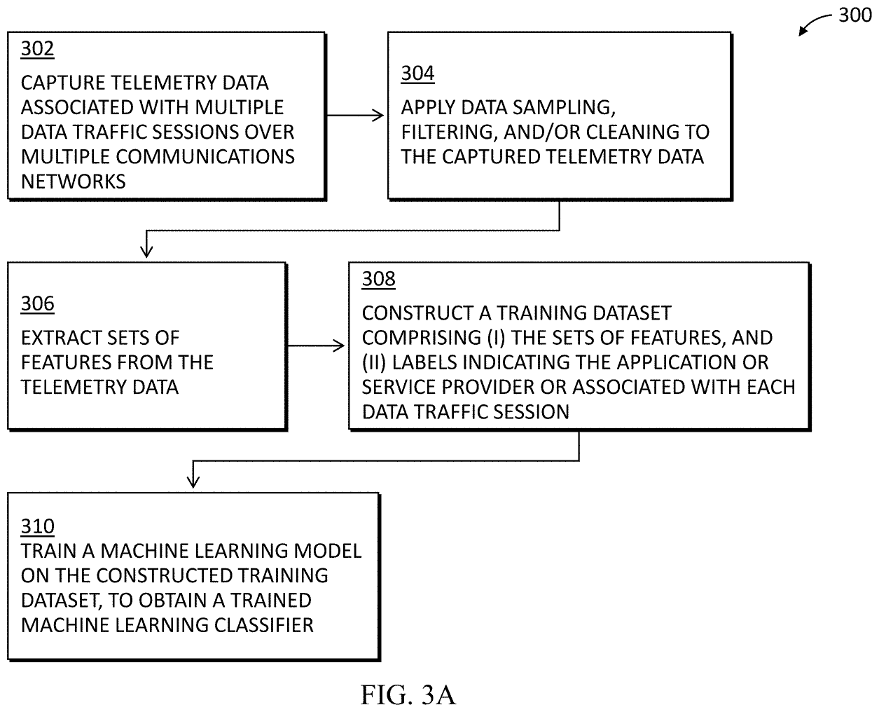

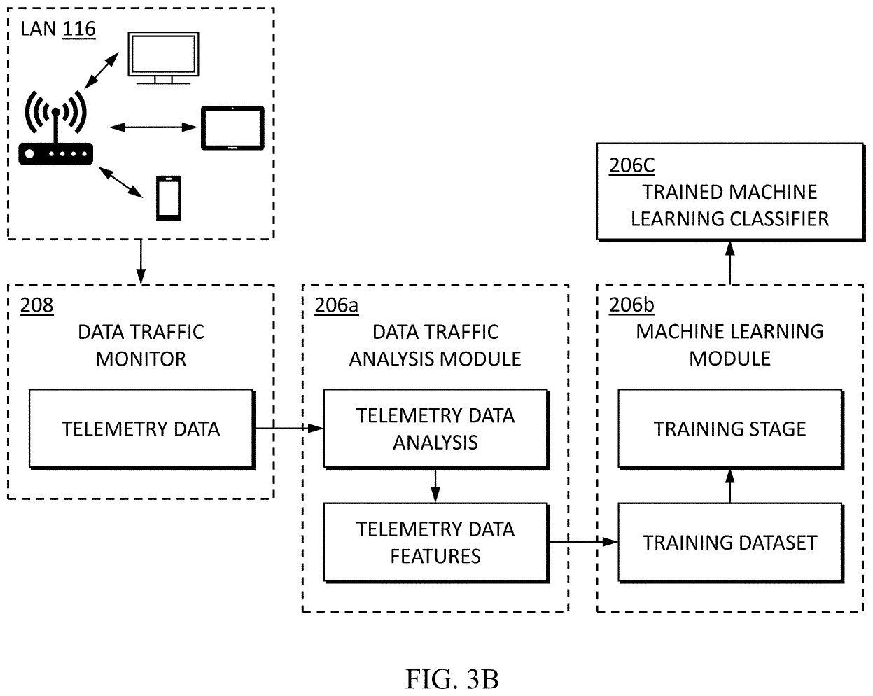

The instructions of system 200 will now be discussed with reference to the flowchart of FIG. 3A, which illustrates the functional steps in a method 300 for training a machine learning model, such as machine learning classifier 206c, to perform automated, real-time, application-level classification of network traffic within a communications network, in accordance with various aspects of the present disclosure. FIG. 3B provides an overview of a pipeline for training a machine learning model of the present disclosure, according to some embodiments.

The various steps of method 300 may either be performed in the order they are presented or in a different order (or even in parallel), as long as the order allows for a necessary input to a certain step to be obtained from an output of an earlier step. In addition, the steps of method 300 may be performed automatically (e.g., by system 200 of FIG. 2), unless specifically stated otherwise.

In some embodiments, in telemetry data capturing step 302, the instructions of system 200 may cause data traffic monitor 208 to monitor and capture sample data traffic flows and telemetry data from a plurality of communications networks, wherein the traffic telemetry data are associated with multiple instances of application or service usage sessions, wherein the service or application are associated with one of the following service categories: media streaming (including audio and video streaming), file downloading, file uploading, online gaming, conferencing, social network usage, internet browsing, VPN session, electronic mail usage, and remote desktop sessions.

In some embodiments, network traffic monitor 208 may collect data traffic flows associated with a set of two or more known applications and/or Internet services, e.g., 2, 3, 4, 5, 10, 15, or more different applications and/or Internet services.

In some embodiments, network traffic monitor 208 may aggregate data packets into sequences or flows comprising IP data packets passing a monitoring point in the network during a certain time interval, such that all packets belonging to a particular flow sample have a set of common properties. In some embodiments, such time interval may be, e.g., 10, 15, 20, 25, 30, 60, 120 seconds or greater.

In some embodiments, telemetry data captured by data traffic monitor 208 may include, for example, the MAC addresses of the associated devices, traffic features captured from the devices' traffic (e.g., which protocols were used, source or destination information, etc.), timing information (e.g., when the devices communicate, sleep, etc.), and/or any other information regarding the devices that can be used to infer their device types. For example, device telemetry data regarding protocols used may represent the presence or absence of a certain protocol in the traffic of the device such as, but not limited to, IPv6, IPv4, IGMPv3, IGMPv2, ICMPv6, ICMP, HTTP/XML, HTTP, etc.

Similarly, data traffic monitor 208 may analyze packet headers, to capture telemetry data about the traffic flows. For example, data traffic monitor 208 may capture the source address and/or port of the particular one or more STAs 102-106 associated with the data traffic flow, the destination address and/or port of Internet services 120-150, the protocol(s) used by each packet included in the traffic flows, the hostname of Internet services 120-150, and/or other header information by analyzing the headers of included packets. Example features in the captured telemetry data may include, but are not limited to, Transport Layer Security (TLS) information (e.g., from a TLS handshake), such as the ciphersuite offered, User Agent information, destination hostname, TLS extensions, etc., HTTP information (e.g., URI, etc.), Domain Name System (DNS) information, ApplicationID, virtual LAN (VLAN) ID, or any other data features that can be extracted from the observed traffic flows. Further information, if available, could also include process hash information from the process on the particular one or more STAs 102-106 that participates in the traffic flows.

In further embodiments, data traffic monitor 208 may also assess the payload of the included packets in the traffic flows, to capture information about the traffic flows. For example, data traffic monitor 208 may perform deep packet inspection (DPI) on one or more of the included packets, to assess the contents of the packets. Doing so may, for example, yield additional information that can be used to determine the application associated with the traffic flows (e.g., the packets were sent by a web browser of a particular one of STAs 102-106, by a videoconferencing application, etc.).

In some embodiments, network traffic monitor 208 may capture data flows and related telemetry data from a plurality of communications networks, wherein the traffic telemetry data are associated with multiple instances of application or service usage sessions, wherein the service or application are associated with one of the following service categories: media streaming (including audio and video streaming), file downloading, file uploading, online gaming, conferencing, social network usage, internet browsing, VPN session, electronic mail usage, and remote desktop sessions.

In some embodiments, the telemetry data may be captured over specified usage periods. For example, network traffic monitor 208 may capture network traffic flows and telemetry data over a specified period of time, such as a period extending between 1 hour and 365 days of usage, e.g., 24 hours of usage. In some embodiments, a specified period of usage time may be a continuous period of usage, e.g., a continuous 24 hours representing usage of the device throughout all hours of the day.

Data traffic monitor 208 may also compute any number of statistics or metrics regarding the traffic flows. For example, data traffic monitor 208 may determine the start time, end time, duration, packet size(s), the distribution of bytes within a flow, etc., associated with the traffic flow by observing included packets.

In some embodiments, the instructions of network traffic monitor 208 may cause system 200 to capture telemetry data associated with the connection context of one or more instances of application or service usage sessions. For example, in some embodiments, in order to fetch a particular service or application usage session, an STA, such as one of STAs 102-106, may open two or more connections, e.g., 1, 2, 3, 4, 5 or more connections, to fetch the multiple resources comprising the requested service. In some embodiments, network traffic monitor 208 may continuously or periodically monitor and sample the established connections, to capture telemetry data associated therewith.

In some embodiments, network traffic monitor 208 may be further configured to generate a record of each flow sample, which may include information about each flow sample that was observed, e.g., an application or service or Internet services associated with the flow sample, characteristic properties of a flow sample (e.g., IP addresses and port numbers) as well as size-based and temporal properties (e.g., packet and byte counters). In some embodiments, network traffic monitor 208 may be further configured to timestamp received flow samples upon packet arrival.

In some embodiments, network traffic monitor 208 may be further configured to determine an application or content or Internet service associated with each flow sample, based on connection parameters such as, but not limited to, domain name, IP address, and/or port numbers. In some embodiments, a domain name may be determined using a Secure Socket Layer (SSL) certificate, which provides a fully qualified domain name associated with a server as verified by a trusted third party service. For example, a reverse DNS lookup or reverse DNS resolution (rDNS) may be carried out by network traffic monitor 208 to determine the domain name associated with an IP address. In other examples, network traffic monitor 208 may determine port numbers associated the IP address, and/or a transport protocol, e.g., Transmission Control Protocol (TCP) and the User Datagram Protocol (UDP). In the case of port number ranges, because many internet resources use a known port or port ranges on their local host as a connection point to which other hosts may initiate communication, network traffic monitor 208 may analyze TCP SYN packets to know the server side of a new client-server TCP connection.

In some embodiments, application and/or Internet service detection based on detecting a URL or a server IP address and associating the URL or IP address with a known domain found, e.g., in repository of domain names associated with a specified application or Internet service. For example, known domain names associated with any particular application or category of service may be identified and added to a database of domain name maintained by system 200, e.g., on storage device 206. In some embodiments, such detection may be further supported by, e.g., an expression or a string (e.g., a regex) which may be associated with a particular application or Internet service (e.g., ‘Netflix’), an expected port range associated with the service type, or an expected protocol associated with the Internet service.

In some embodiments, a database of known domain names associated with particular applications or Internet services may be obtained using, e.g., a dedicated crawler configured to systematically browses the Internet for the purpose of identifying and indexing domain names based on a type, content, etc. A crawler typically travels over the internet and accesses resources. The crawler inspects, e.g., the content or other attributes of resources. The crawler then follows hyperlinks to other resources. The results of the crawling are then extracted into a repository, which may be queried to find content that is relevant to a particular task. Thus, for example, a URL or IP address associated with a service being provided to an STA in LAN 116 may be matched with an entry in a domain repository maintained by system 200. In such case, the service may be determined to be a category of service associated with the matched domain name.

With reference back to FIG. 3, in some embodiments, in step 304, the instructions of network traffic monitor 208 may cause system 200 to sample and/or filter the collected data packets, such that only certain packets are retained and forwarded for further processing within system 200. In some embodiments, a combination of several sampling and filtering steps can be adopted to select only packets of interest, to reduce computational load of subsequent stages or processes as well as the consumption of bandwidth and memory. For example, systematic sampling may be applied, wherein only every Nth packet is selected in a periodic sampling scheme. In other example, random sampling may be applied to select packets in accordance with a random process. In some embodiments, network traffic monitor 208 may be further configured to apply one or more filtering schemes, e.g., to select packets where specific fields within the packet (and/or the router state) are equal to a specified value or inside a specified value range. In other examples, packets that are used for handshake generation and do not contain any useful information about the protocol or service being used may be removed (e.g., SYN, ACK, FIN packets).

In some embodiments, in step 306, the telemetry data captured in step 302 and processed in step 304 may be forwarded to data traffic analysis module 206a, for further processing. In some embodiments, the instructions of data traffic analysis module 206a may cause system 200 to receive the flow samples obtained by network traffic monitor 208, and process the data to extract sets of features from each flow sample. In some embodiments, the extracted features may include, but are not limited to, data flow level or temporal (i.e., time-related) features, as well as packet-level or size-based features. In some embodiments, each of these features may be associated with one of the following categories of features:

Accordingly, in some embodiments, data traffic analysis module 206a may be configured to calculate one or more data traffic features associated with the following feature categories, with respect to each data traffic flow sample, based on a moving time window interval of between 5-240 seconds, e.g., 30 seconds:
Data spikiness: The ratio of time windows within a flow sample showing data rates or packet rates which spike above one or more specific thresholds. In some embodiments, the one or more thresholds may reflect static values, e.g., 1 KB, 2 KB, 3 KB, 100 KB, 200 KB, 300 KB, or 10 packets, 30 packets, 50 packets, etc. In some embodiments, the threshold may be a dynamic threshold whose value may reflect, e.g., the average data/packet rate within a particular time window or a series of two or more time windows, plus the standard deviation of the data/packet rate.
Data spikes attributes: Statistics and metrics calculated with respect to identified data rate or packet rate spikes, such as. Such statistics and metrics may be calculated with respect to the width, amplitude, and frequency or occurrence or data spikes, and may include, but are not limited to, mean values, average values, minimum values, maximum values, standard deviation, variance, and distribution.
Packet Rate: The number of packets in rate and packets out rate sent over one or more time windows, including, but not limited to, mean values, average values, minimum values, maximum values, standard deviation, variance, and distribution.
Packet sizes: Mean values, average values, minimum values, maximum values, standard deviation, variance, and distribution of packet sizes transmitted over one or more time windows.
Ratio of inbound-to-outbound data: The mean ratio between inbound and outbound data and/or packets over all time windows in a flow sample, as well as minimum, maximum, variance, and/or distribution of such ratio.
Ratio of valid time windows: The ratio of time windows having a number of inbound packets that is greater than a specified threshold.
Inter-arrival timing of packets: A measure of time periods within a flow sample in which inbound (e.g., ‘quiet in’) or outbound data (e.g., ‘quiet out’) amounts to less than a specified threshold, e.g., 50B.

In some embodiments, data traffic analysis module 206a may be further configured to calculate the following additional features, including, but not limited to:
Packets in rate: Total number of data packets received within the specified time window.
Bytes in rate: Total number of bytes received within the specified time window.
Packets out rate: Total number of data packets transmitted within the specified time window.
Bytes out rate: Total number of bytes transmitted within the specified time window.
Packet inter-arrival times: Average, minimum, maximum, variance, and/or distribution of the duration between packet arrivals within the flow sample.
DPS: Mean, minimum, maximum, variance, and/or distribution of download packet size.
UPS: Mean, minimum, maximum, variance, and/or distribution of upload packet size.
DPR: Mean, minimum, maximum, variance, and/or distribution of download packet rate.
UPR: Mean, minimum, maximum, variance, and/or distribution of upload packet rate.
RR: Ratio between the mean, minimum, maximum, variance, and/or distribution of the rate of download to upload packets.
RS: Ratio between the mean, minimum, maximum, variance, and/or distribution of the in bytes rate to out bytes rate.
Flow sample data throughput: Total, mean, minimum, maximum, and/or variance of data flow sample per session.

In some embodiments, data traffic analysis module 206a may be further configured to calculate a set of features, based on the telemetry data associated with the connection context or connection multiplexity of the one or more instances of application or service usage sessions. In a non-limiting example, data traffic analysis module 206a may be configured to calculate at least the following features:
A number of active connections associated with a particular application or service usage instance.
A number of opened and closed connections per specified time period (e.g., between 10-240 seconds).
An order of opening of different connection types. Connection type may be determined based on a trained classifier which classifies connections into two or more classes, based, e.g., of a clustering or similar algorithm.
Mean, average, maximum, minimum, standard deviation, and distribution of connection open durations, and total upload and download data volumes passing therethrough.

In some embodiments, data traffic analysis module 206a may be configured to calculate the various features detailed in step 304, separately for each connection identified within the context of a particular application or service usage instance, and/or separately for each connection type identified within the context of a particular application or service usage instance.

In some embodiments, the present disclosure provides for a preprocessing stage within step 306, to preprocess the extracted parameters. In some embodiments, the preprocessing stage may comprise at least one of feature normalizing, feature selection, feature extraction, dimensionality reduction, and/or any other suitable preprocessing method or technique. In some embodiments, a feature selection step may be used to limit the number of parameters actually used to train the machine learning model. This way, the training process of the machine learning model does not use irrelevant or redundant features which may lead to adverse effects on the accuracy of the trained model, and may make the model more computationally expensive.

In some embodiments, in step 308, the instructions of machine learning module 206b may cause system 200 to construct a training dataset comprising the plurality of sets of features extracted in step 306 from the telemetry data collected and preprocessed in steps 302 and 304.

In some embodiments, each feature set may be labeled with a label indicating the particular application or Internet service associated therewith. In some embodiments, a training dataset of the present disclosure comprises a set of labeled examples, from which a machine learning model of the present disclosure may be trained to build a set of classification rules, to classify unseen examples. In some embodiments, a training dataset of the present disclosure may be labeled using manual, semi-automated, or automated methods. For example, in some embodiments, a training dataset may comprise a portion of labeled data, combined with unlabeled features.

In some embodiments, in step 310, a machine learning model of the present disclosure may be trained on a training dataset of the present disclosure, to obtain a trained machine learning model, such as machine learning classifier 206c, configured to perform automated, real-time, application-level classification of network traffic within a communications network

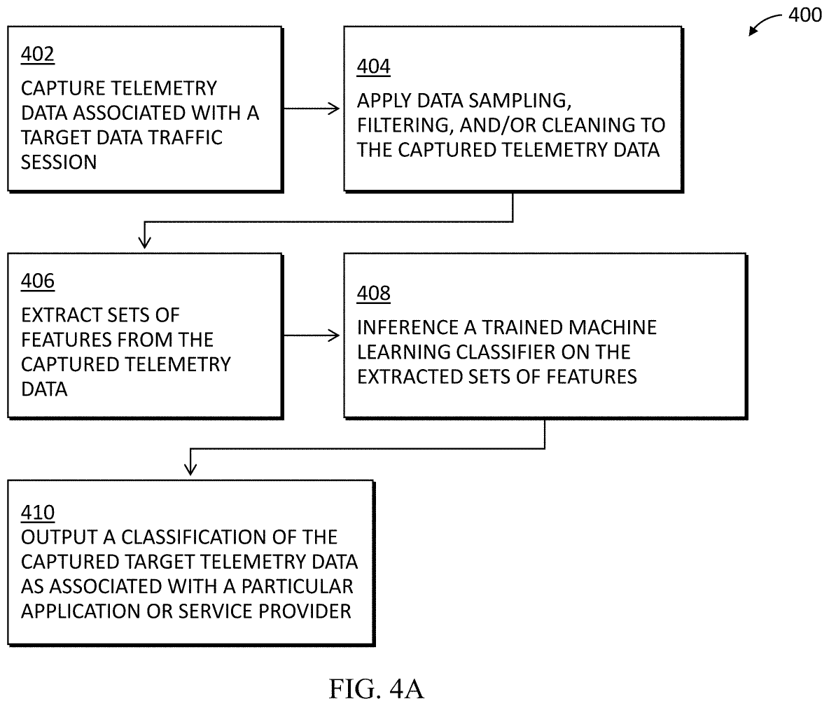

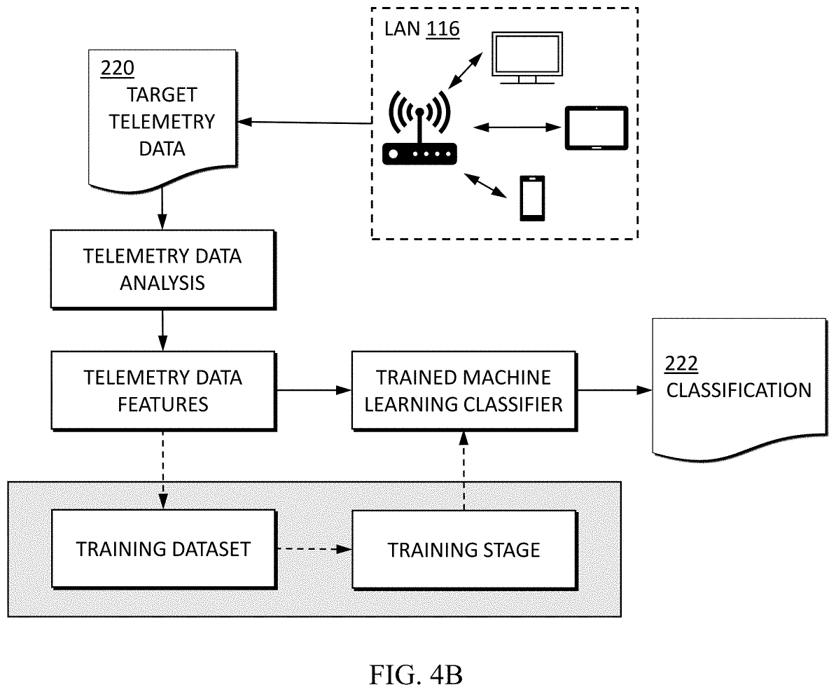

The instructions of system 200 will now also be discussed with reference to the flowchart of FIG. 4A, which illustrates the functional steps in a method 400 for automated, real-time, application-level classification of network traffic within a communications network, by inferencing a trained machine learning classifier, such as machine learning classifier 206c, in accordance with various aspects of the present disclosure. FIG. 4B provides an overview of a pipeline for inferencing a machine learning classifier of the present disclosure, such as machine learning classifier 206c, according to some embodiments.

The various steps of method 400 may either be performed in the order they are presented or in a different order (or even in parallel), as long as the order allows for a necessary input to a certain step to be obtained from an output of an earlier step. In addition, the steps of method 400 may be performed automatically (e.g., by system 200 of FIG. 2), unless specifically stated otherwise.

In some embodiments, in step 402, the instructions of system 200 may cause network traffic monitor 208 to monitor and collect a target input telemetry data 220 associated with an unseen application or service usage instance by an end device, such one of STAs 102-106, within a communication network, such as LAN 116. For example, with reference to FIG. 1, an STA 102 within LAN 116 may initiate a data traffic session with an unseen application or Internet service, e.g., Internet service 130, to stream media over an internet connection. In some embodiments, in order to fetch the service, the STA 102 may open one or more connections, e.g., two or more parallel connections to fetch the multiple resources comprising the requested service. In some embodiments, network traffic monitor 208 may continuously or periodically monitor and sample the one or more established connections, e.g., 1, 2, 3, 4, 5 or more connections (which may be referred to as the ‘connection context’), to capture a target telemetry data 220 associated with the service being provided to STA 102.

In some embodiments, in step 404, network traffic monitor 208 may be further configured to sample and/or filter the captured target telemetry data 220, as described above with reference to step 304 in method 300.

In some embodiments, in step 406, the target telemetry data 220 captured and preprocessed in steps 402 and 404 may be forwarded to data traffic analysis module 206a, for further processing. In some embodiments, the instructions of machine learning module 206b may cause system 200 to receive the target telemetry data 220 obtained by network traffic monitor 208, and process the data to extract one or more sets of features from the captured target telemetry data 220, consistent with the feature calculating and extraction processes described above with reference to step 306 in method 300.

In some embodiments, in step 408, the instructions of machine learning classifier 206c may cause system 200 to inference machine learning classifier 206c on the one or more sets of features extracted in step 406 from the target telemetry data 220.

In step 410, the instructions of machine learning classifier 206c may cause system 200 to output a classification 222 of the input target telemetry data 220, as associated with a particular application or Internet service.

FIG. 4B illustrates an inferencing pipeline of a machine learning classifier 206c of the present disclosure, using a machine learning model trained as detailed above. A target data traffic flow captured in real-time is used to extract data traffic features that are fed into the machine learning classifier. The classifier's output indicates a specified Internet service associated with a target flow. Certain implementations may optionally allow the model to be updated in real-time, by continuously re-training the model using features and label obtained during real-time inference of the model.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range—10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

1. A system comprising:
at least one hardware processor; and
a non-transitory computer-readable storage medium having stored thereon program instructions, the program instructions executable by the at least one hardware processor to:
receive, at a network interface, telemetry data associated with a plurality of data flows, wherein each of said plurality of data flows is associated with an instance of usage of one of a set of known applications or Internet services,
segment each of said data flows into time windows,
process said telemetry data to calculate, for each of said data flows, a set of features associated with at least one of the following categories of features:
(i) a ratio of said time windows within each of said data flows having a data rate or packet rate which spike above a predetermined threshold,
(ii) a ratio between inbound and outbound data or packets within each of said time windows in each of said data flows, and
(iii) a value associated with time periods within each of said time windows in each of said data flow having inbound or outbound data or packet rates below a predetermined amount, and
at a training stage, train a machine learning model on a training dataset comprising:
(iv) said sets of features for each of said data flows, and
(v) labels indicating an identity a particular said application or Internet service associated with said data flow,
to obtain a trained machine learning classifier configured to output a classification of unseen target telemetry data as originating from a particular one of said applications or Internet services.

2. The system of claim 1, wherein said program instructions are further executable to apply, at an inference stage, said trained machine learning classifier to unseen target telemetry data, to classify said unseen target telemetry data as originating from a particular one of said applications or internet services.

3. The system of claim 1, wherein said predetermined threshold is a dynamic threshold expressed as a function of said data rate or packet rate over each of said time windows.

4. The system of claim 1, wherein said training dataset further comprises one or more statistics calculated with respect to at least some of said categories of features, and wherein said statistics are selected from the group consisting of: mean, average, minimum value, maximum value, variance, standard deviation, and distribution.

5. The system of claim 1, wherein at least some of said instances of usage comprise two or more data flow connections, and wherein said program instructions are further executable to calculate features associated with connection multiplexity selected from the group consisting of: a number and type of said connections associated with a particular one of said instances of usage; a number of opened and closed connections per each of said time windows associated with a particular one of said instances of usage; an order of opening of different connection types associated with a particular one of said instances of usage; and statistics calculated with respect to each of said features associated with connection multiplexity.

6. The system of claim 5, wherein said training dataset further comprises said features associated with connection multiplexity.

7. The system of claim 6, wherein said training dataset further comprises one or more statistics calculated with respect to at least some of said features associated with connection multiplexity, wherein said statistics are selected from the group consisting of: mean, average, minimum value, maximum value, variance, standard deviation, and distribution.

8. A computer-implemented method comprising:
receiving, at a network interface, telemetry data associated with a plurality of data flows, wherein each of said plurality of data flows is associated with an instance of usage of one of a set of known applications or Internet services;
segmenting each of said data flows into time windows;
processing said telemetry data to calculate, for each of said data flows, a set of features associated with at least one of the following categories of features:
(i) a ratio of said time windows within each of said data flows having a data rate or packet rate which spike above a predetermined threshold,
(ii) a ratio between inbound and outbound data or packets within each of said time windows in each of said data flows, and
(iii) a value associated with time periods within each of said time windows in each of said data flow having inbound or outbound data or packet rates below a predetermined amount; and
at a training stage, training a machine learning model on a training dataset comprising:
(iv) said sets of features for each of said data flows, and
(v) labels indicating an identity a particular said application or Internet service associated with said data flow,
to obtain a trained machine learning classifier configured to output a classification of unseen target telemetry data as originating from a particular one of said applications or Internet services.

9. The method of claim 8, further comprising applying, at an inference stage, said trained machine learning classifier to unseen target telemetry data, to classify said unseen target telemetry data as originating from a particular one of said applications or internet services.

10. The method of claim 8, wherein said predetermined threshold is a dynamic threshold expressed as a function of said data rate or packet rate over each of said time windows.

11. The method of claim 8, wherein said training dataset further comprises one or more statistics calculated with respect to at least some of said categories of features, and wherein said statistics are selected from the group consisting of: mean, average, minimum value, maximum value, variance, standard deviation, and distribution.

12. The method of claim 8, wherein at least some of said instances of usage comprise two or more data flow connections, further comprising calculating features associated with connection multiplexity selected from the group consisting of: a number and type of said connections associated with a particular one of said instances of usage; a number of opened and closed connections per each of said time windows associated with a particular one of said instances of usage; an order of opening of different connection types associated with a particular one of said instances of usage; and statistics calculated with respect to each of said features associated with connection multiplexity.

13. The method of claim 12, wherein said training dataset further comprises said features associated with connection multiplexity.

14. The method of claim 13, wherein said training dataset further comprises one or more statistics calculated with respect to at least some of said features associated with connection multiplexity, wherein said statistics are selected from the group consisting of: mean, average, minimum value, maximum value, variance, standard deviation, and distribution.

15. A computer program product comprising a non-transitory computer-readable storage medium having program instructions embodied therewith, the program instructions executable by at least one hardware processor to:
receive, at a network interface, telemetry data associated with a plurality of data flows, wherein each of said plurality of data flows is associated with an instance of usage of one of a set of known applications or Internet services;
segment each of said data flows into time windows;
process said telemetry data to calculate, for each of said data flows, a set of features associated with at least one of the following categories of features:
(i) a ratio of said time windows within each of said data flows having a data rate or packet rate which spike above a predetermined threshold,
(ii) a ratio between inbound and outbound data or packets within each of said time windows in each of said data flows, and
(iii) a value associated with time periods within each of said time windows in each of said data flow having inbound or outbound data or packet rates below a predetermined amount; and
at a training stage, train a machine learning model on a training dataset comprising:
(iv) said sets of features for each of said data flows, and
(v) labels indicating an identity a particular said application or Internet service associated with said data flow,
to obtain a trained machine learning classifier configured to output a classification of unseen target telemetry data as originating from a particular one of said applications or Internet services.

16. The computer program product of claim 15, wherein said program instructions are further executable to apply, at an inference stage, said trained machine learning classifier to unseen target telemetry data, to classify said unseen target telemetry data as originating from a particular one of said applications or internet services.

17. The computer program product of claim 15, wherein said predetermined threshold is a dynamic threshold expressed as a function of said data rate or packet rate over each of said time windows.

18. The computer program product of claim 15, wherein said training dataset further comprises one or more statistics calculated with respect to at least some of said categories of features, and wherein said statistics are selected from the group consisting of: mean, average, minimum value, maximum value, variance, standard deviation, and distribution.

19. The computer program product of claim 15, wherein at least some of said instances of usage comprise two or more data flow connections, and wherein said program instructions are further executable to calculate features associated with connection multiplexity selected from the group consisting of: a number and type of said connections associated with a particular one of said instances of usage; a number of opened and closed connections per each of said time windows associated with a particular one of said instances of usage; an order of opening of different connection types associated with a particular one of said instances of usage; and statistics calculated with respect to each of said features associated with connection multiplexity.

20. The computer program product of claim 19, wherein said training dataset further comprises said features associated with connection multiplexity.
